(19) United States
(12) Patent Application Publication
(10) Pub. No.: US 2003/0098854 A1
(43) Pub. Date: May 29, 2003

(54) Integrated touchscreen and keys in same matrix

(76) Inventors: Edward Robert Laliberte, Barboursville, VA (US); William Keene Adams, Charlottesville, VA (US)

Correspondence Address: CANTOR COLBURN, LLP, 55 GRIFFIN ROAD SOUTH, BLOOMFIELD, CT, 06002

(21) Appl. No.: 09/683,165

(22) Filed: Nov. 28, 2001

(51) Int. Cl. G09G 5/00

(52) U.S. Cl. 345/173

(57) ABSTRACT

An operator interface having integrated touchscreen and keys is disclosed. A resistive touch membrane for the operator interface includes touch regions for a display window of the operator interface, a membrane keypad comprising depressible keys, and a connector system containing electrical connectors. Each touch region is associated with a pair of electrical connectors within the connector system and each key is associated with a pair of electrical connectors within the connector system. Each key shares one electrical connector in common with one of the touch regions.

### BACKGROUND OF INVENTION

This invention relates generally to operator interface products. More particularly, this invention relates to the integration of a touchscreen with keys within such operator interface products.

Operator interface products are ideal for a broad range of industrial applications, such as food packaging, chemical processing, and automotive manufacturing. They can improve the performance of existing systems by providing the power, responsiveness, and flexibility demanded in advanced manufacturing and industrial systems.

Certain operator interface products include a self-contained, solid state industrial display system incorporating display screens and keypads. These types of operator interface products provide a low-cost human-machine interface enabling the transfer of data from a programmable logic controller (PLC) and other intelligent control devices to a comprehensive operator terminal. Such operator interface products are ideal replacements for discrete operator input and annunciation devices. With varying configurable options, some systems can meet applications ranging from simple pushbutton replacement to complex interface.

Some operator interfaces are able to utilize a wide range of applications software, which supports configuration of simple or complex operator interfaces. Other features may include a serial port for communications, programmable function keys, and a back-lit LCD with touch screen. In particular, certain operator interface products of today support a separate 6×8 discrete resistive touch matrix and a 2×8 dome key matrix. By having these matrices separated, additional hardware and firmware must be used to determine whether the touch screen or keypad is being pressed.

### SUMMARY OF INVENTION

The above discussed and other drawbacks and deficiencies of the prior art are overcome or alleviated by an operator interface having integrated touchscreen and keys. In an exemplary embodiment of the invention, a resistive touch membrane for the operator interface includes touch regions for a display window of the operator interface, a membrane keypad comprising depressible keys, and a connector system containing electrical connectors. Each touch region is associated with a pair of electrical connectors within the connector system and each key is associated with a pair of electrical connectors within the connector system. Each key shares one electrical connector in common with one of the touch regions.

The above-discussed and other features and advantages of the present invention will be appreciated and understood by those skilled in the art from the following detailed description and drawings.

### BRIEF DESCRIPTION OF DRAWINGS

Referring to the exemplary drawings wherein like elements are numbered alike in the several FIGS.:

FIG. 1 is a front perspective view of an operator interface;

FIG. 2 is a diagrammatic view of the front of a membrane within the operator interface of FIG. 1 showing the matrix of the touchscreen;

FIG. 3 is a front plan view of the membrane of FIG. 2;

FIG. 4 is a rear plan view of FIG. 3;

FIG. 5 is a side plan view of FIG. 3;

FIG. 6 is a perspective view of a receptacle for use in this invention;

FIG. 7 is a diagrammatic view of the connector pinouts for the membrane of FIG. 2; and,

FIG. 8 is a circuit diagram for the combined touch screen and dome key matrix of this invention.

### DETAILED DESCRIPTION

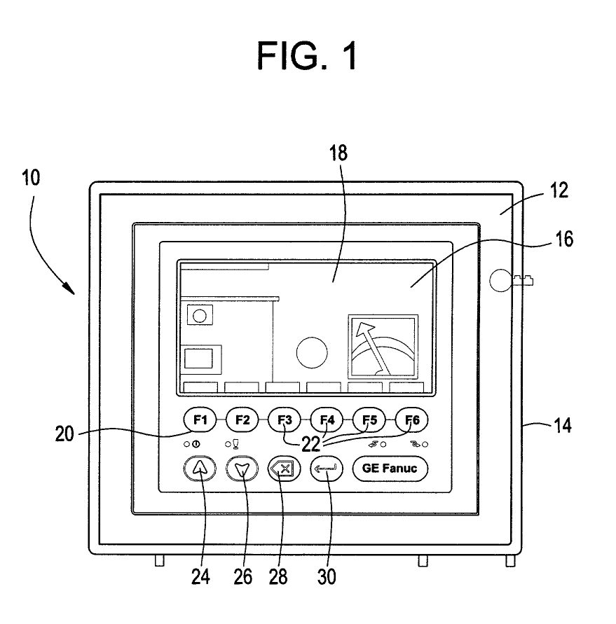

Referring to FIG. 1, an operator interface 10 is shown which includes a housing 12. The housing 12 is made up of two molded enclosures forming the front section 14 and the rear section (not shown) of the unit. The front section 14 includes a large central aperture 16 giving access to the display window 18 and the membrane keypad 20. System hardware (not shown) may be mounted to the rear section. The rear section of the housing 12 may be a simple cover designed to fully enclose the system hardware. The front section 14 and the rear section of the housing 12 may be secured to one another by snapping them together, such as by plastic clips located near each corner, or by other means of connection.

The display window 18 preferably features a bright display area, such as may be accomplished using a 240×128 pixel LCD display for good visibility. Also, in conjunction with the software installed in the operator interface 10, the display window 18 is capable of supporting graphic objects such as bar meters, trend graphs, dynamic bit maps, and push-buttons.

The membrane keypad 20 features six programmable function keys 22, labeled F1, F2, F3, F4, F5, and F6, although other labels are within the scope of this invention. Also, the membrane keypad 20 includes four navigation and editing buttons, in particular, up and down keys 24, 26, a delete key 28, and an enter key 30. Icons including up and inverted triangles, an “X” and a left pointing arrow are imprinted on the membrane keypad 20 for representing the up and down keys, delete key, and enter key, respectively, although other icons are within the scope of this invention.

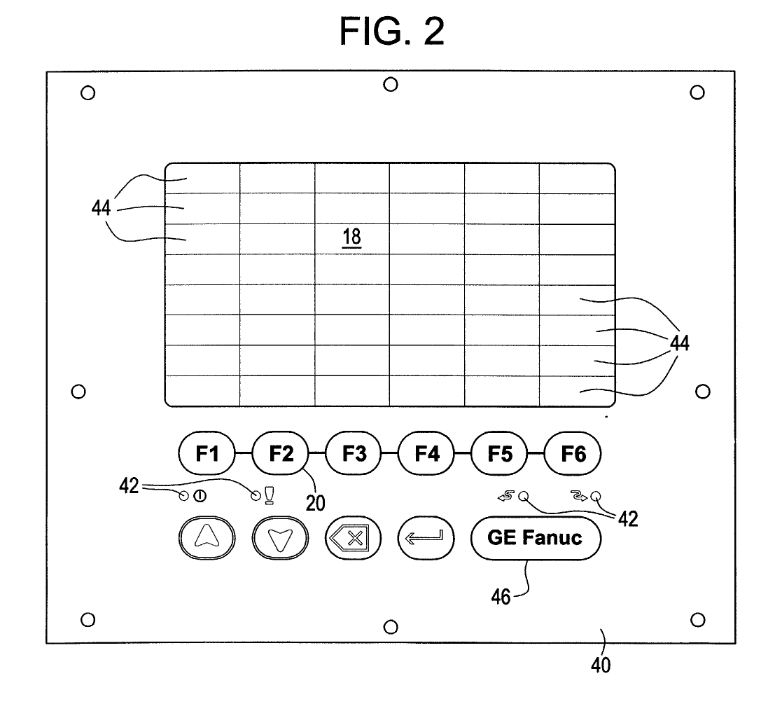

FIG. 2 demonstrates the membrane 40 which is housed within the housing 12 of the operator interface 10. The membrane 40 is a resistive touch membrane divided into rows and columns providing touch regions that can be configured by the user.

The membrane 40 includes the display window 18 and the membrane keypad 20. The display window 18 preferably contains a 6 column by 8 row matrix touch screen. The lines defining the columns and rows of the matrix would not actually be visible in the display window 18, but are included for a graphical representation of the matrix. As shown, the touch screen portion of the membrane 40 includes 48 touch regions 44.

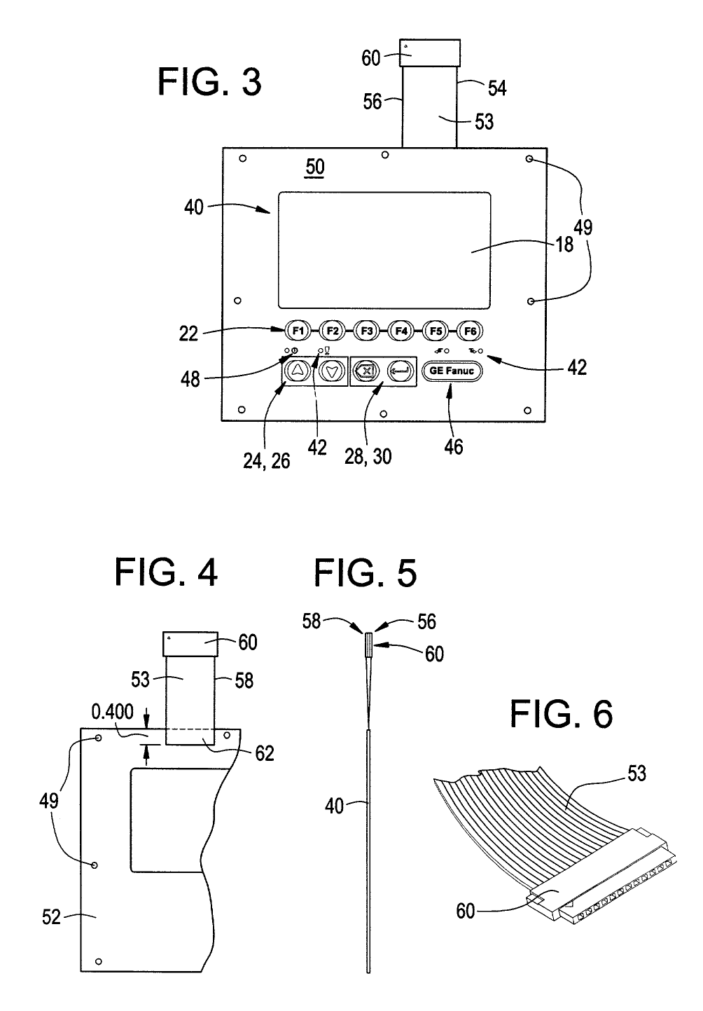

The membrane 40 further includes ten dome embossed keys defining the membrane keypad 20, and four embossed LED windows 42. Each LED window 42 may include an accompanying graphic 48 (see FIG. 3). In addition to the function keys 22 and the navigation and editing buttons 24, 26, 28, and 30, the membrane 40 may include a logo area 46 for depicting the logo or identity of the manufacturer or trade name of the operator interface 10.

Turning now to FIGS. 3-5, the membrane 40 includes a number of mounting holes 49 for securing the membrane 40 within the housing 12. The front surface 50 of the membrane 40 is shown in FIG. 3 and the rear surface 52 is shown in FIG. 4. Extending from the rear surface 52 is a connector system 54 which includes a first connector 56 (“Connector 1”) and a second connector 58 (“Connector 2”). The connectors 56, 58 of the connector system 54 may each include a receptacle 60, such as a Berg brand Clincher, at an end of the connectors 56, 58. The connectors 56, 58 extend from the rear surface 52, with a cable or wire ribbon 53, such that an overlapping section 62 of the connector system 54 is formed. The receptacles 60 preferably each include a plurality of electrical connectors, in particular a multiple position square post female receptacle, as shown in FIG. 6, with appropriate spacing for receiving a compatible male contact. It would be within the scope of this invention to replace the receptacle 60 with a male connector, e.g. pins, insertable within a corresponding female receptacle.

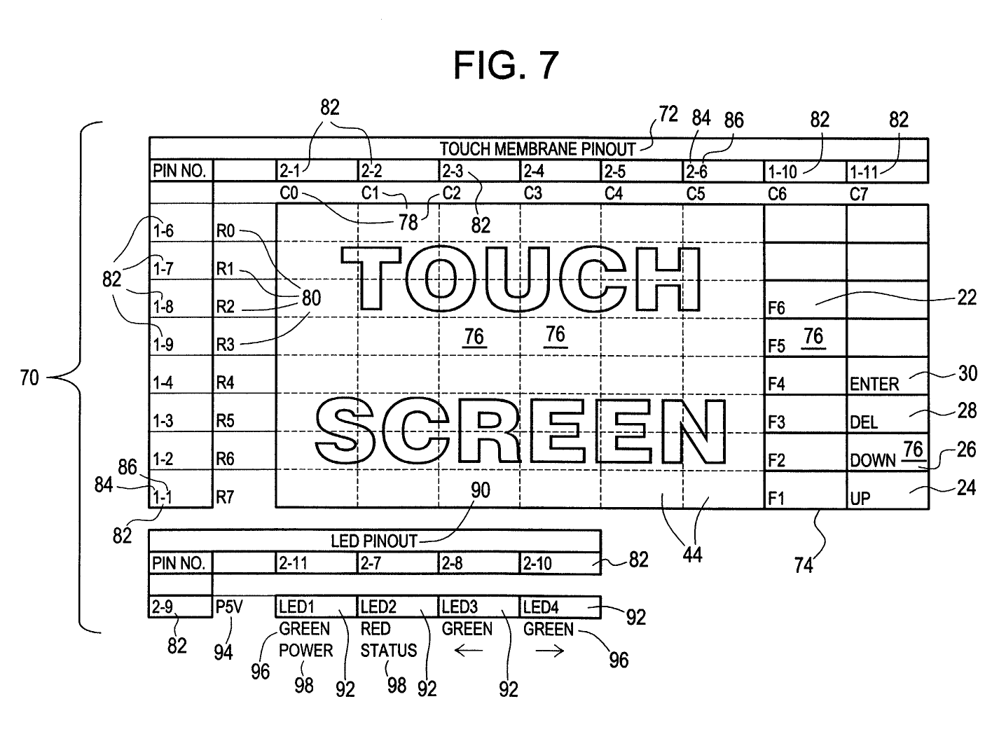

Turning now to FIG. 7, a representation of the 8×8 matrix 74 having “pinouts” 70 is shown. The touch membrane pinout 72 is an 8×8 matrix 74 which includes regions 76 for the touch regions 44 of the display window 18, the function keys 22 of the membrane keypad 20, and the four navigation and editing buttons 24, 26, 28, and 30 of the membrane keypad 20. The eight columns 78 of this 8×8 matrix 74 are labeled C0, C1, C2, C3, C4, C5, C6, and C7 while the eight rows 80 of the 8×8 matrix 74 are labeled R0, R1, R2, R3, R4, R5, R6, and R7. The connector pinout numbers 82 are listed next to each row 80 and column 78. The connector pinout numbers 82 each include two numbers. The first number 84 refers to one of the connectors 56, 58. For example, if the connector pinout number 82 is “1-1”, then the first number 84 “1” refers to the first connector 56. If the connector pinout number 82 is “2-6”, then the first number 84 “2” refers to the second connector 58. The second number 86 in each of the connector pinout numbers 82 refers to the pin number. For example, if the connector pinout number 82 is “1-1”, then the second number 86 “1” refers to pin 1. If the connector pinout number 82 is “2-6”, then the second number 86 “6” refers to pin 6. Thus, connector pinout number “1-1” refers to connector 1 pin 1, and connector pinout number “2-6” refers to connector 2 pin 6.

The touch membrane pinout 72 includes all of the regions 76 which can complete an electrical path. For example, if the region 76 corresponding to column 2, row 3 (C2-R3) is touched or otherwise activated by an operator, then the electrical path between connector 1 pin 9 and connector 2 pin 3 is completed. If the region 76 corresponding to column 7, row 6 (C7-R6) is touched or otherwise activated by an operator, then the electrical path between connector 1 pin 2 and connector 1 pin 11 is completed. The completion of an electrical path indicates to a microprocessor (not shown) connected to the connector system 54 that a particular task is to be completed. As can be seen from FIG. 7, each of the touch regions 44 and the keys 22, 24, 26, 28, and 30 are associated with a distinct pair of electrical connectors. Also, each of the keys 22, 24, 26, 28, and 30 share one electrical connector in common with a touch region, because each key shares a row with touch regions 44. No touch region or key, however, shares the same pair of electrical connectors as each association is distinct. By having the keys 22, 24, 26, 28, and 30 share one common electrical connector with touch regions 44, it is not necessary for the programmable logic circuit to first determine whether the touch screen or keypad is being depressed, and the combined matrix 74 results in lower cost and improved performance of the operator interface 10.

The LED pinout 90 is also part of the pinouts 70. The LED pinout 90 includes a 1×4 matrix, with only one row and four columns. All of the LED regions 92 are connected to connector 2 pin 9 which is connected to a power source 94. If the microprocessor activates connector 2 pin 11, then an electrical connection will be made between connector 2 pin 11 and connector 2 pin 9, thus illuminating LED1. Likewise, if the microprocessor activates connector 2 pin 10, then an electrical connection will be made between connector 2 pin 10 and connector 2 pin 9, thus illuminating LED 4.

Colors 96 indicate the colors for the LED's, and functions 98 indicate the function indicators of the LED's. Both colors 96 and functions 98 could be altered by the manufacturer as desired. Because the LED's are microprocessor driven rather than operator driven, the LED pinout 90 includes a separate matrix from the matrix 74.

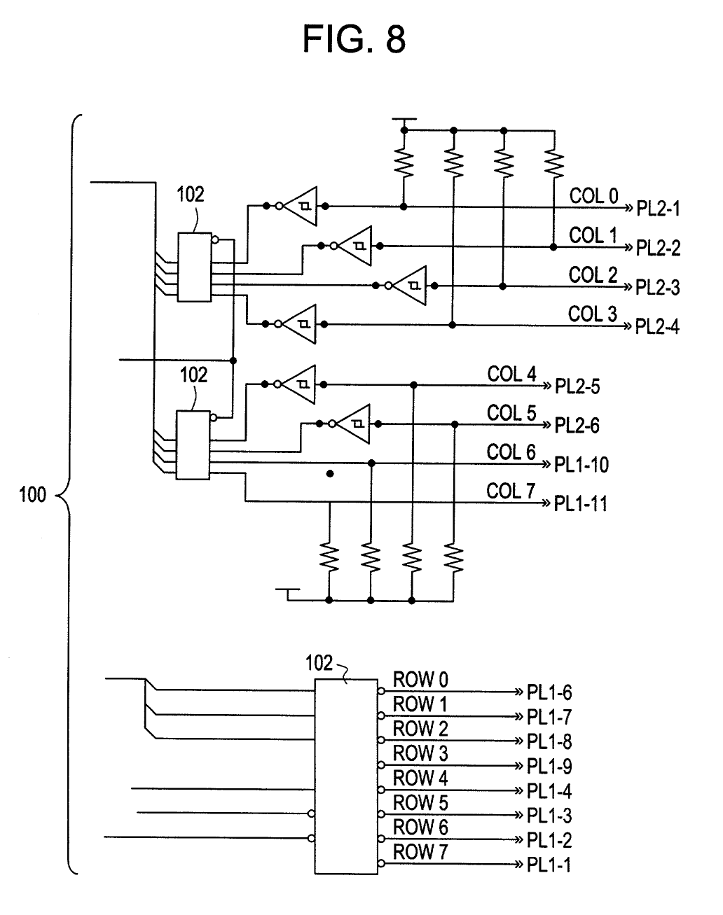

Turning now to FIG. 8, a schematic for exemplary circuitry 100 for the combined 8×8 matrix touch screen and dome keys 74 is shown. The combined 8×8 matrix touch screen and dome keys 74 may be wired to a single 8-bit port, or comparable acceptable port. The circuit may use a decoder to decode the appropriate row being driven from the 3-bit address, the 8 column data lines may be wired to an inverter with hysteresis that is wired to octal buffers and line drivers with 3-state outputs 102 (labeled 74HCT244 in FIG. 8), to the 8-bit data bus. The combined touch and key membrane 40 is an input device that is polled by the software.

By having a separate 6×8 discrete resistive touch matrix and a 2×8 dome key matrix instead of the combined 8×8 matrix 74 of resistive touch and dome keys of this invention, additional hardware and firmware must be used to determine whether the touch screen 18 or keypad 20 is depressed. Using the single combined 8×8 matrix 74 has thus shown a cost savings in componentry. Also, this enhancement resulted in less firmware overhead required to determine what touch or key region 76 is pressed, and thus the new 8×8 matrix 74 has resulted in increased performance of the operator interface 10. Combining the 6×8 resistive touch matrix and the 2×8 dome key matrix into a single matrix allows for the touch screen 18 and dome keys 20 to be read by a single 8-bit port. Thus, the present invention is advantageous in that the design of the operator interface 10 has been simplified and lowered in cost, while performance has been increased.

While a specific example of an 8×8 combined matrix has been described for combining the 6×8 touch screen and the 2×8 dome keys matrices, it should be noted that it is within the scope of this invention to combine any size matrices of resistive touch screens and dome keys. For example, with the teachings of this invention, one could provide an 8×8 combined matrix for a 7×8 touch screen and 1×8 keys, or a 16×16 combined matrix for a 10×16 touch screen and 6×16 keys, etc. In other words, an A×C touch screen matrix can be combined with a B×C touch screen matrix to form a D×C touch screen matrix, where A+B=D, and D may equal C as in the specific example presented herein. It should be noted that just because a matrix is said to have a particular number of rows and columns, the actual implementation of the operator interface may not necessarily utilize all of the available rows and columns. For example, the 2×8 dome key matrix shown in FIG. 7 does not have a key associated with each of its regions 76.

The operator interface 10 containing the improved membrane 40 is usable within a larger industrial system containing control devices, a programmable logic controller, and the operator interface 10 itself. Also, a method of arranging associations between electrical connectors, touch regions, and dome keys of an operator interface is defined by this invention wherein the combined matrix 74 is created by associating each row and each column with an electrical connector, associating each touch region with a cell, each dome key with a cell, and additionally associating each dome key with cells residing in rows containing cells associated with touch regions which allows for the combination of the touch regions and dome keys within the same matrix.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A resistive touch membrane for an operator interface, the membrane comprising:
touch regions for a display window of the operator interface;
a membrane keypad comprising depressible keys; and
a connector system containing electrical connectors extending from the touch membrane;
wherein each touch region is associated with a pair of electrical connectors within the connector system, each key is associated with a pair of electrical connectors within the connector system, and wherein each key shares one electrical connector in common with one of the touch regions.

2. The resistive touch membrane of claim 1 wherein each key is associated with one electrical connector which is not associated with any of the touch regions.

3. The resistive touch membrane of claim 1 wherein electrical connector association of the touch regions and the keys is organized in a combined matrix, wherein association of an electrical connector with a touch region or a key is determined by location of the touch region or key within the combined matrix.

4. The resistive touch membrane of claim 1 wherein the touch regions are divided into an A×C matrix and the keys are divided into a B×C matrix, the membrane comprising a combined D×C matrix for the touch regions and the keys for determining association of electrical connectors, wherein A+B=D.

5. The resistive touch membrane of claim 1 wherein the connector system includes a first receptacle and a second receptacle, each receptacle containing a subset of the electrical connectors.

6. The resistive touch membrane of claim 5 wherein each touch region is associated with one electrical connector from the first receptacle and one electrical connector from the second receptacle, and each key is associated with a pair of electrical connectors from the first receptacle.

7. The resistive touch membrane of claim 5 further comprising LED's, wherein each LED is associated with a pair of electrical connectors from the second receptacle.

8. The resistive touch membrane of claim 1 wherein touching a touch region completes an electrical connection between the pair of electrical connectors associated to that touch region and pressing a key completes an electrical connection between the pair of electrical connectors associated to that key.

9. The resistive touch membrane of claim 1 wherein the keys include 10 dome keys comprising function keys, navigation keys, and editing keys.

10. The resistive touch membrane of claim 1 wherein the touch regions are located within the display window, the display window including an LCD display.

11. The resistive touch membrane of claim 1 wherein each touch region and each key is associated with a distinct pair of electrical connectors not associated with any other touch region or key.

12. An operator interface comprising:
a housing; and,
a resistive touch membrane contained within the housing, the membrane comprising:
touch regions for a display window of the operator interface;
a membrane keypad comprising keys;
a connector system containing electrical connectors;
wherein each touch region is associated with a pair of electrical connectors within the connector system, each key is associated with a pair of electrical connectors within the connector system, and wherein each key shares one electrical connector in common with one of the touch regions.

13. The operator interface of claim 12 wherein each key is associated with one electrical connector which is not associated with any of the touch regions.

14. The operator interface of claim 12 wherein electrical connector association of the touch regions and the keys is organized in a combined matrix, wherein association of an electrical connector with a touch region or a key is determined by location of the touch region or key within the combined matrix.

15. The operator interface of claim 12 wherein the touch regions are divided into an A×C matrix and the keys are divided into a B×C matrix, the membrane comprising a combined D×C matrix for the touch regions and the keys for determining association of electrical connectors, wherein A+B=D.

16. The operator interface of claim 12 wherein the connector system includes a first receptacle and a second receptacle, each receptacle containing a subset of the electrical connectors.

17. The operator interface of claim 16 wherein each touch region is associated with one electrical connector from the first receptacle and one electrical connector from the second receptacle, and each key is associated with a pair of electrical connectors from the first receptacle.

18. The resistive touch membrane of claim 12 wherein touching a touch region completes an electrical connection between the pair of electrical connectors associated to that touch region and pressing a key completes an electrical connection between the pair of electrical connectors associated to that key.

19. A method of arranging associations between electrical connectors, touch regions, and dome keys of an operator interface, the method comprising:
providing an association matrix, the matrix including rows and columns and a plurality of cells defined by its location within a row and a column;
associating each row with one electrical connector;
associating each column with one electrical connector;
associating each touch region with a cell within the matrix;
associating each dome key with a cell within the matrix; and,
associating each dome key with cells residing in rows containing cells associated with touch regions.

20. An industrial management system comprising:
at least one control device;
a programmable logic controller; and, an operator interface communicating with the at least one control device and the programmable logic controller, the operator interface comprising:
a housing; and,
a resistive touch membrane contained within the housing, the membrane comprising:
touch regions for a display window of the operator interface;
a membrane keypad comprising buttons;
a connector system containing electrical connectors;
wherein each touch region is associated with a pair of electrical connectors within the connector system, each button is associated with a pair of electrical connectors within the connector system, and wherein each button shares one electrical connector in common with one of the touch regions.

21. The industrial management system of claim 20 wherein the connector system of the resistive touch membrane is connected to the programmable logic controller.
